(19) United States
(12) Patent Application Publication
(10) Pub. No.: US 2018/0109087 A1
(43) Pub. Date: Apr. 19, 2018

(54) SINGLE-BLADE-DOUBLE-EDGED STEEL WIRE ROPE SHEARS

(71) Applicant: NUSHARP INC., TAICHUNG (TW)

(72) Inventors: SUNG-YU CHANG, TAICHUNG (TW); CHUN-CHIEH LIAO, TAICHUNG (TW)

(21) Appl. No.: 15/638,272

(22) Filed: Jun. 29, 2017

(30) Foreign Application Priority Data
Oct. 19, 2016 (TW) 105215888

(51) Int. Cl. H02G 1/12

(52) U.S. Cl. CPC H02G 1/1214; H02G 1/1236; H02G 1/1204; H02G 1/12; H02G 1/1297

(57) ABSTRACT

A pair of single-blade-double-edged steel wire rope shears, includes: a first cutting member and a second cutting member pivotally connected to each other. The first cutting member includes a first grip and a first blade, the first blade includes a first lateral cutting section and a first bottom cutting section; the second cutting member includes a second grip and a second blade, the second blade includes a second lateral cutting section and a second bottom cutting section; when the first and second grips pivot toward each other, the first and second lateral cutting sections cut a to-be-cut object inserted therebeween, meanwhile, the first and second bottom cutting sections also cut the to-be-cut object, so as to form at least three cutting points on the to-be-cut object, and as a result, the pair of single-blade-double-edged steel wire rope shears can improve cutting efficiency.

### BACKGROUND

### Field of the Invention

The present invention relates to a device for cutting steel wire ropes, and more particularly to a pair of single-blade-double-edged steel wire rope shears.

### Related Prior Art

A pair of conventional steel wire rope shears 100′ disclosed in Taiwan Patent No. M459957 is shown in FIGS. 1A and 1B, and includes a left rod 1′, a right rod 2′, a jaw 11′ at the top end of the left rod 1′, and a jaw 21′ at the top end of the right rod 2′. The jaws 11′, 21′ cooperate with each other to cut the object (such as a steel wire rope) to be cut.

Another pair of conventional steel wire rope shears 200′ disclosed in Taiwan Patent No. M427723 is shown in FIGS. 2A and 2B, and includes a first blade member 10′ and a second blade member 20′. The first blade member 10′ includes a first shaft 111 and a first handle 12′, and the first shaft 111 includes a first blade portion 111′. The second blade member 20 includes a second shaft 211 and a second handle 22′, and the second shaft 211 includes a second blade portion 211′ which cooperates with the first blade portion 111′ to cut the object (such as a steel wire rope).

Each of the pairs of the steel wire rope shears 100′ and 200′ is provided with two jaws 11′, 21′ (as shown in FIGS. 1A and 1B) or two blade portions 111′, 211′ (as shown in FIGS. 2A and 2B) to bite or cut the object to be cut from both sides. For example, as shown in FIG. 1B, the two jaws 11′, 21′ create two cutting points P1′ and P2′ on the object 30′ to be cut, and as shown in FIG. 2B, the first and second blade portions 111′, 211′ also create two cutting points P1′ and P2′ on the object 30′ to be cut, which makes it inconvenient for the user to apply force.

The present invention has arisen to mitigate and/or obviate the afore-described disadvantages.

### SUMMARY

One objective of the present invention is to provide a pair of single-blade-double-edged steel wire rope shears capable of providing at least three cutting points in total, and as a result, the present invention can save 8-13% of cutting force, as compared with the conventional steel wire rope shears with two cutting points.

To achieve the above objective, a pair of single-blade-double-edged steel wire rope shears in accordance with the present invention comprises: a first cutting member and a second cutting member pivotally connected to each other by a pivot member, characterized in that: the first cutting member includes a first grip and a first blade, the first blade is provided at one side thereof facing the second cutting member with a first cutting edge, the first cutting edge includes a first lateral cutting section and a first bottom cutting section; the second cutting member includes a second grip and a second blade, the second blade is provided at one side thereof facing the first cutting member with a second cutting edge, the second cutting edge includes a second lateral cutting section and a second bottom cutting section; when the first and second grips pivot toward each other, the first lateral cutting section and the second lateral cutting section cut a to-be-cut object which is inserted between the first and second lateral cutting sections, meanwhile, the first bottom cutting section and the second bottom cutting section also cut the to-be-cut object, so as to form at least three cutting points on the to-be-cut object.

Preferably, the first lateral cutting section and the first bottom cutting section define a first angle of 75 to 90 degrees therebetween, and the second lateral cutting section and the second bottom cutting section define a second angle of 75 to 90 degrees therebetween.

Preferably, an inclination of the first lateral cutting section, the first bottom cutting section, the second lateral cutting section and the second bottom cutting section is less than 90 degrees.

Preferably, an inclination of the first lateral cutting section, the first bottom cutting section, the second lateral cutting section and the second bottom cutting section is preferably 75 to 89 degrees.

Preferably, the first lateral cutting section and the second lateral cutting section are located at opposite sides of an axis of the pivot member.

Preferably, the first lateral cutting section and the second lateral cutting section are located at the same side of an axis of the pivot member.

Preferably, the first lateral cutting section is disconnected from the first bottom cutting section, and the second lateral cutting section is disconnected from the second bottom cutting section.

Preferably, when the first lateral cutting section moves away from the second lateral cutting section to reach a maximum width, a combined length of the first and second bottom cutting sections which are parallel to each other is equal to or larger than a distance between the first and second lateral cutting sections.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1A shows a part of a pair of steel wire rope shears disclosed in Taiwan Patent No. M459957;

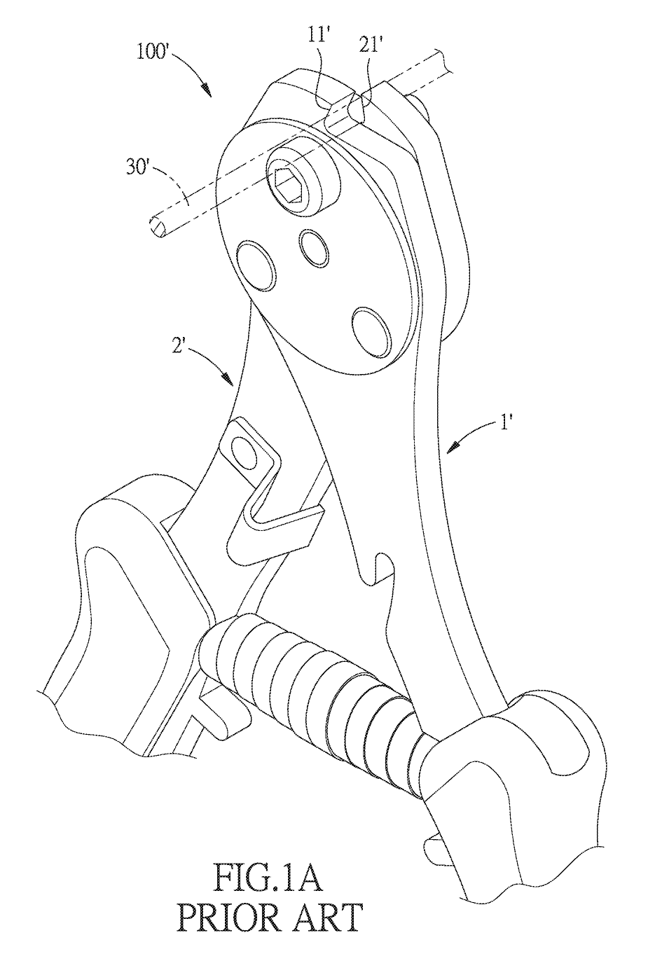

FIG. 1B is an enlarged view of a part of FIG. 1A;

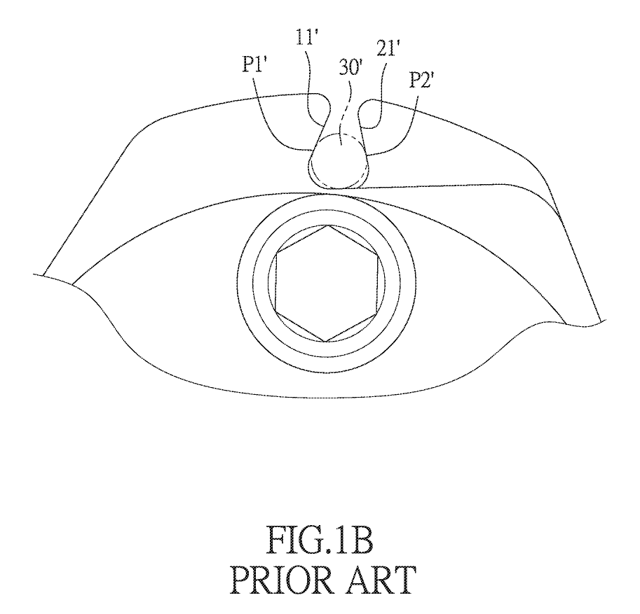

FIG. 2A shows a part of a pair of steel wire rope shears disclosed in Taiwan Patent No. M427723;

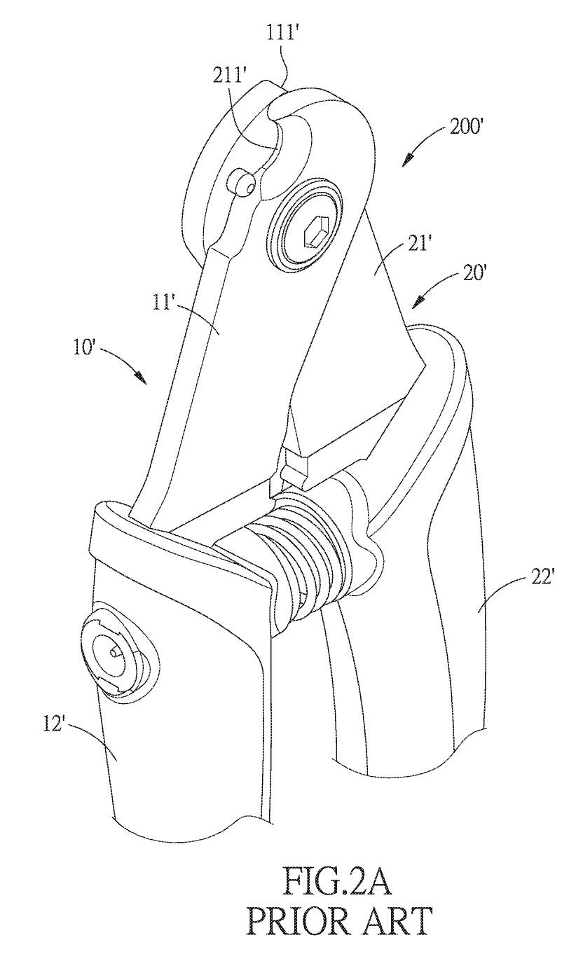

FIG. 2B is an enlarged view of a part of FIG. 2A;

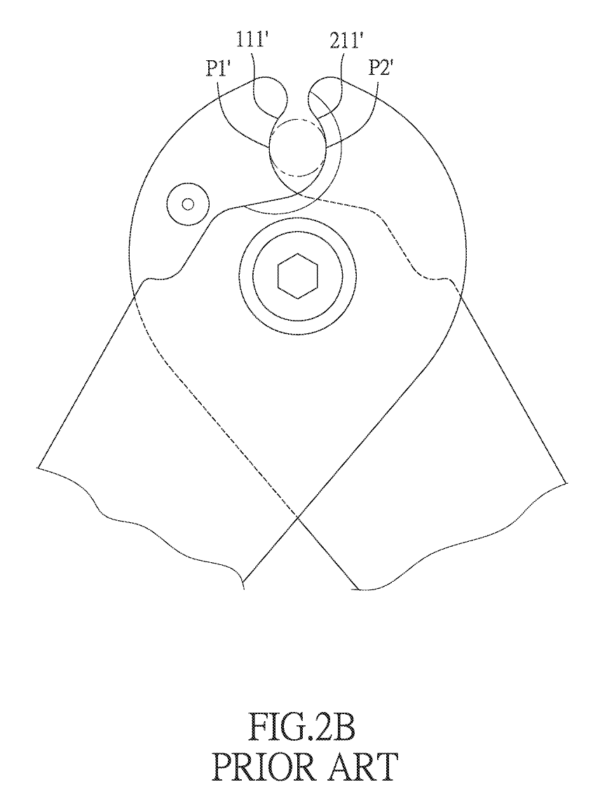

FIG. 3 is an exploded view of the pair of single-blade-double-edged steel wire rope shears in accordance with a preferred embodiment of the present invention;

FIG. 4 is a perspective view of a part of the pair of single-blade-double-edged steel wire rope shears in accordance with the preferred embodiment of the present invention;

FIG. 5 is a plan view showing a prior-to-cutting state of the pair of single-blade-double-edged steel wire rope shears of the present invention;

FIG. 6 is a plan view showing an after-cutting state of the pair of single-blade-double-edged steel wire rope shears of the present invention; and

FIG. 7 is a plan view of the pair of single-blade-double-edged steel wire rope shears in accordance with another preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

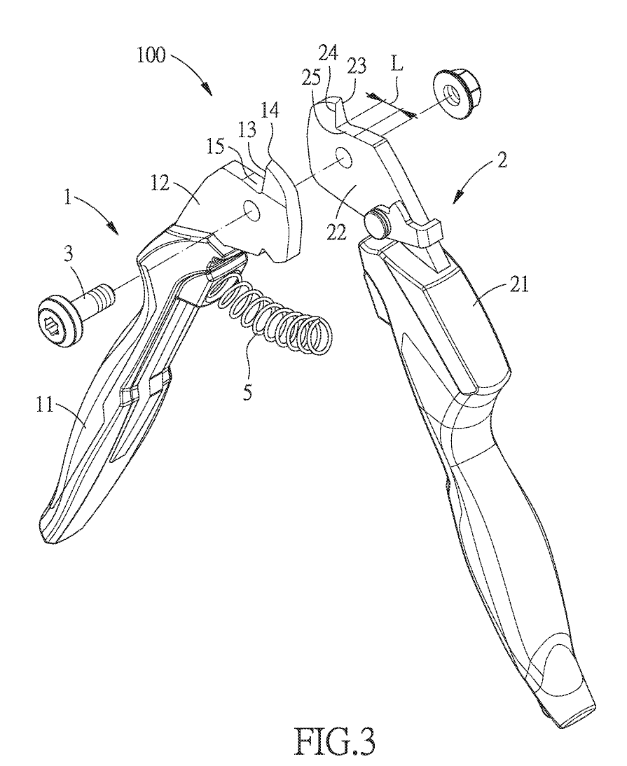

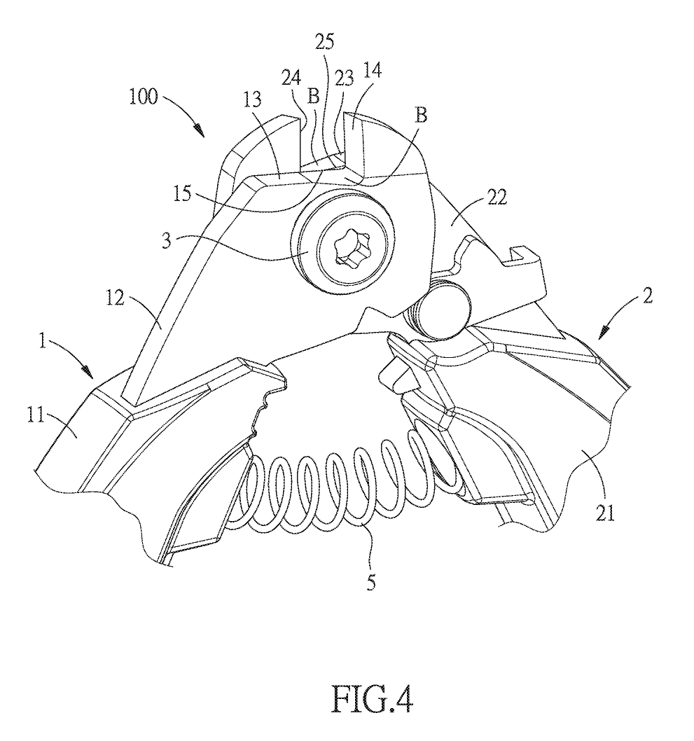

Referring to FIGS. 3-7, the pair of single-blade-double-edged steel wire rope shears 100 in accordance with a preferred embodiment of the present invention, includes: a first cutting member 1 and a second cutting member 2 which are pivotally connected to each other by a pivot member 3 (such as a pin).

The first cutting member 1 includes a first grip 11 and a first blade 12. The first blade 12 is provided at one side thereof facing the second cutting member 2 with a first cutting edge 13, and the first cutting edge 13 includes a first lateral cutting section 14 and a first bottom cutting section 15 which can be connected to or disconnected from the first lateral cutting section 14.

The second cutting member 2 includes a second grip 21 and a second blade 22. The second blade 22 is provided at one side thereof facing the first cutting edge 13 of the first cutting member 1 with a second cutting edge 23. The second cutting edge 23 includes a second lateral cutting section 24 and a second bottom cutting section 25 which can be connected to or disconnected from the second lateral cutting section 24, and the first cutting edge 13 and the second cutting edge 23 can define a roughly U-shaped cutting gap before performing cutting operation.

An elastic member 5 is connected between the first and second grips 11, 21, so that the first and second grips 11, 21 can be returned to their original positions after cutting operation.

The first lateral cutting section 14 and the first bottom cutting section 15 define a first angle of 75 to 90 degrees therebetween, the second lateral cutting section 24 and the second bottom cutting section 25 define a second angle of 75 to 90 degrees therebetween, and the first angle is equal to the second angle. An inclination B of the first lateral cutting section 14, the first bottom cutting section 15, the second lateral cutting section 24 and the second bottom cutting section 25 is less than 90 degrees, and is preferably 75 to 89 degrees.

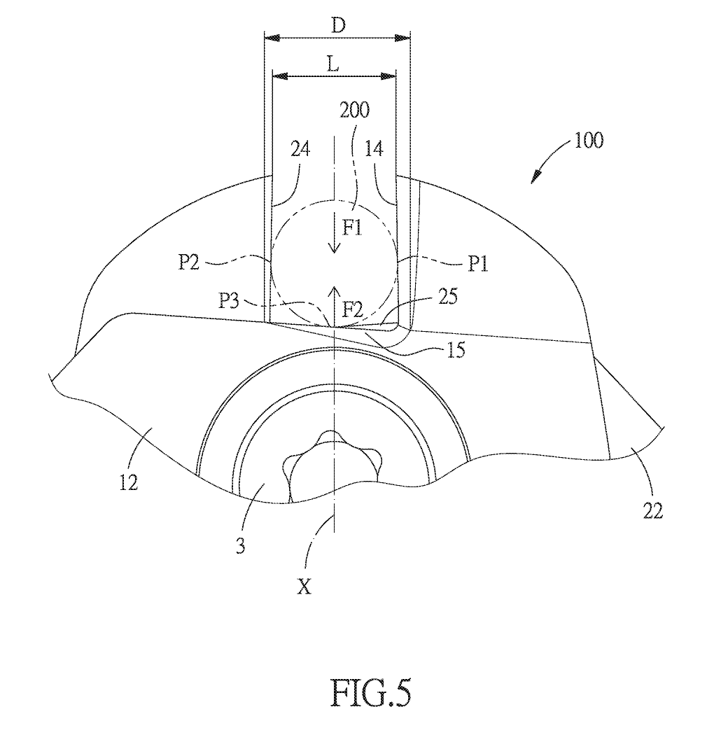

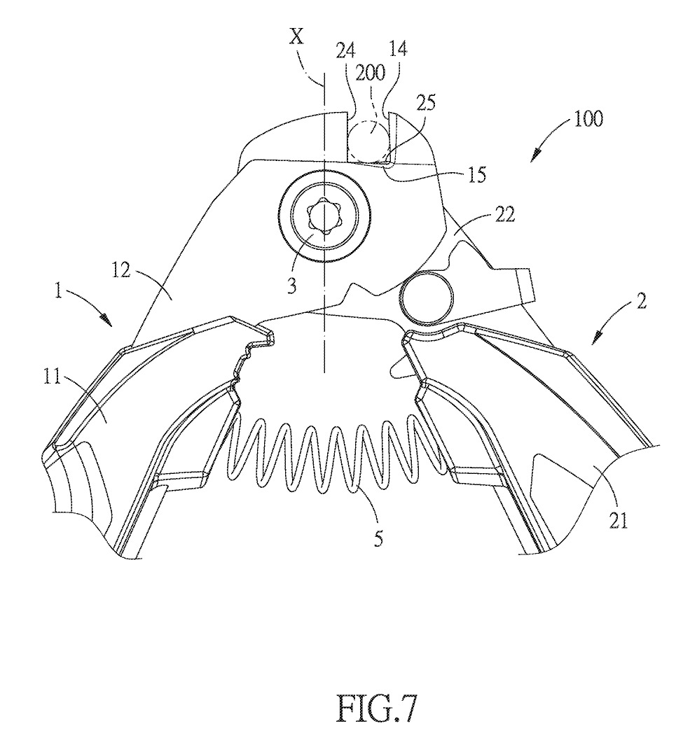

The first lateral cutting section 14 and the second lateral cutting section 24 can be located at opposite sides (as shown in FIG. 5) or the same side (as shown in FIG. 7) of an axis of the pivot member 3.

Referring then to FIGS. 3-6 again, when the first and second grips 11, 21 pivot toward each other, the first lateral cutting section 14 and the second lateral cutting section 24 can cut two opposite lateral edges of a to-be-cut object (such as a steel wire rope) 200 which is inserted in the U-shaped cutting gap, meanwhile, the first bottom cutting section 15 and the second bottom cutting section 25 can cut the bottom edge of the to-be-cut object 200, so as to form at least three cutting points on the to-be-cut object 200. Namely, at least three cutting points can be created when the first and second angles are approximately 75 degrees, which includes: two cutting points P1 and P2 formed by the first lateral cutting section 14 and the second lateral cutting section 24, and at least one cutting point P3 formed by the first bottom cutting section 15 and the second bottom cutting section 25. When the to-be-cut object 200 has a relatively large diameter, more than two cutting points (not shown in this embodiment) will be formed at the first bottom cutting section 15 and the second bottom cutting section 25. When the first and second angles are approximately 90 degrees, about four cutting points will be formed, namely, a cutting point will be formed at each of the first lateral cutting section 14, the second lateral cutting section 24, the first bottom cutting section 15 and the second bottom cutting section 25.

Please refer to the table 1 as below, which shows the cutting strength (kgf) comparison between the pair of single-blade-double-edged steel wire rope shears 100 of the invention and the conventional steel wire rope shears (HWC6):

TABLE 1

| | Rope diameter | | | | | |
|---|---|---|---|---|---|---|
| | φ5 | | φ4 | | φ3 | |
| | type | | | | | |
| | φ0.33 × 19 × 6 | | φ0.26 × 19 × 6 | | φ0.32 × 7 × 6 | |
| | The | | The | | The | |
| sample | invention | HWC6 | invention | HWC6 | invention | HWC6 |
| 1 | 47.0 | 51.9 | 28.7 | 31.6 | 18.9 | 22.3 |
| 2 | 45.8 | 50.2 | 27.9 | 32.4 | 19.4 | 21.2 |
| 3 | 47.7 | 49.7 | 27.7 | 32.3 | 21.2 | 21.3 |
| 4 | 46.4 | 51.4 | 29.0 | 31.6 | 18.9 | 22.8 |
| 5 | 46.1 | 49.4 | 29.4 | 33.0 | 19.8 | 21.9 |
| Average | 46.6 | 50.5 | 28.5 | 32.2 | 19.6 | 21.9 |

The average value of the above table 1 shows that the present invention saved 8% of the cutting force applied to the rope ϕ0.33×19×6, namely, (50.5-46.6)/46.6=0.08; saved 13% of the cutting force applied to the rope ϕ0.26×19×6, namely (32.2−28.5)/28.5=0.13; and saved 12% of the cutting force applied to the rope ϕ0.32×7×6, namely (21.9−19.6)/19.6=0.12. Namely, the pair of single-blade-double-edged steel wire rope shears 100 of the present invention can save 8-13% of cutting force, as compared with the conventional steel wire rope shears (HWC6).

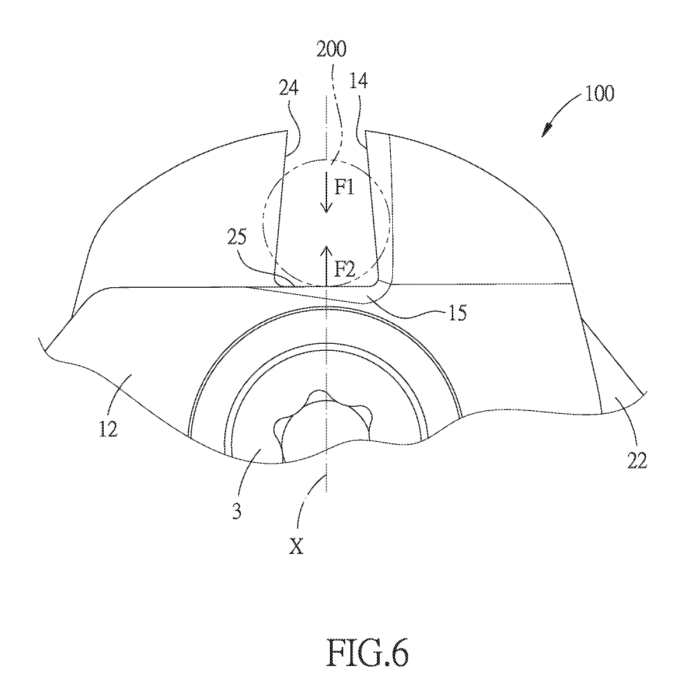

In addition to the two cutting points formed by the first and second lateral cutting sections 14, 24, the first and second bottom cutting sections 15, 25 also further provide at least one cutting point, thus forming at least three cutting points in total, and as a result, the present invention can save 8-13% of cutting force, as compared with the conventional steel wire rope shears with two cutting points. Besides, when the first and second lateral cutting sections 14, 24 pivot toward each other, as shown in FIG. 6, the tip ends of the first and second lateral cutting sections 14, 24 move close to each other rapidly, and the U-shaped cutting gap narrows gradually, the two cutting points P1, P2 on the to-be-cut object 200 will move gradually toward the upper half portion of the to-be-cut object 200 to produce a downward pressing force F1 applied to the to-be-cut object 200 to press the first and second bottom cutting sections 15, 25. Meanwhile, an upward pushing force F2 will be produced at the cutting point formed by the first and second bottom cutting sections 15, 25 to push the to-be-cut object 200 toward the first and second lateral cutting sections 14, 24, so that the to-be-cut object 200 can be reliably secured to and cut by the first and second lateral cutting sections 14, 24 and the first and second bottom cutting sections 15, 25, which consequently improves the cutting efficiency.

Referring then to FIG. 5, when the U-shaped cutting gap reaches its maximum width, the first and second bottom cutting sections 15, 25 are parallel to each other, at this moment, the combined length L of the parallel first and second bottom cutting sections 15, 25 is equal to or larger than a distance D between the first and second lateral cutting sections 14, 24, which allows the to-be-cut object 200 to be reliably cut when placed in the U-shaped cutting gap, consequently improving the cutting efficiency.

While we have shown and described various embodiments in accordance with the present invention, it is clear to those skilled in the art that further embodiments may be made without departing from the scope of the present invention.

What is claimed is:

1. A pair of single-blade-double-edged steel wire rope shears comprising: a first cutting member and a second cutting member pivotally connected to each other by a pivot member, characterized in that:
the first cutting member includes a first grip and a first blade, the first blade is provided at one side thereof facing the second cutting member with a first cutting edge, the first cutting edge includes a first lateral cutting section and a first bottom cutting section;
the second cutting member includes a second grip and a second blade, the second blade is provided at one side thereof facing the first cutting member with a second cutting edge, the second cutting edge includes a second lateral cutting section and a second bottom cutting section;
when the first and second grips pivot toward each other, the first lateral cutting section and the second lateral cutting section cut a to-be-cut object which is inserted between the first and second lateral cutting sections, meanwhile, the first bottom cutting section and the second bottom cutting section also cut the to-be-cut object, so as to form at least three cutting points on the to-be-cut object.

2. The pair of single-blade-double-edged steel wire rope shears as claimed in claim 1, wherein the first lateral cutting section and the first bottom cutting section define a first angle of 75 to 90 degrees therebetween, and the second lateral cutting section and the second bottom cutting section define a second angle of 75 to 90 degrees therebetween.

3. The pair of single-blade-double-edged steel wire rope shears as claimed in claim 2, wherein an inclination of the first lateral cutting section, the first bottom cutting section, the second lateral cutting section and the second bottom cutting section is less than 90 degrees.

4. The pair of single-blade-double-edged steel wire rope shears as claimed in claim 3, wherein an inclination of the first lateral cutting section, the first bottom cutting section, the second lateral cutting section and the second bottom cutting section is preferably 75 to 89 degrees.

5. The pair of single-blade-double-edged steel wire rope shears as claimed in claim 1, wherein the first lateral cutting section and the second lateral cutting section are located at opposite sides of an axis of the pivot member.

6. The pair of single-blade-double-edged steel wire rope shears as claimed in claim 1, wherein the first lateral cutting section and the second lateral cutting section are located at the same side of an axis of the pivot member.

7. The pair of single-blade-double-edged steel wire rope shears as claimed in claim 1, wherein the first lateral cutting section is disconnected from the first bottom cutting section, and the second lateral cutting section is disconnected from the second bottom cutting section.

8. The pair of single-blade-double-edged steel wire rope shears as claimed in claim 1, wherein when the first lateral cutting section moves away from the second lateral cutting section to reach a maximum width, a combined length of the first and second bottom cutting sections which are parallel to each other is equal to or larger than a distance between the first and second lateral cutting sections.
